(19) United States
(12) Patent Application Publication
(10) Pub. No.: US 2009/0255164 A1
(43) Pub. Date: Oct. 15, 2009

(54) APPARATUS FOR THE DISTRIBUTION OF AN ATTRACTANT

(76) Inventor: Rhys Jones, Queensland (AU)

Correspondence Address: MYERS BIGEL SIBLEY & SAJOVEC, PO BOX 37428, RALEIGH, NC, 27627, US

(21) Appl. No.: 12/303,027

(22) PCT Filed: May 30, 2007
(86) PCT No.: PCT/AU07/00754

§ 371 Date: Dec. 1, 2008

(30) Foreign Application Priority Data
Jun. 1, 2006 (AU) 2006902988

(51) Int. Cl. A01K 97/02; A01K 97/00

(52) U.S. Cl. 43/4.5; 43/44.99

(57) ABSTRACT

There is disclosed an apparatus for dispersing an attractant having a housing (10) having a first plurality of apertures (11), a rotatable insert (20) for carrying the attractant and positionable within said housing, the insert including a second plurality of apertures (22) which can be aligned with the first plurality of apertures (11) so as to provide a plurality of openings (41) for the distribution of said attractant between the insert (20) and said housing (10) and a closure adapted (30) to engage the housing (10) and retain the insert (20) therein whereby selective rotation of the insert (20) relative to said housing (10) varies the area of the plurality of openings (41) in order to vary the rate of dispersion of the attractant.

### BACKGROUND OF THE INVENTION

1. Field of the Invention

The present invention relates to the distribution of attractants, such as berley for aquatic animals. In particular although not exclusively, the present invention relates to an apparatus for the controlled release of attractant.

2. Discussion of the Background Art

Many recreational and sports fishermen utilise berley or other such attractants to increase the likelihood of catching their quarry. Typically the distribution of the berley is done by hand where the angler tosses pieces of pilchard, squid or the like into the water to create a berley trail. Distributing the berley in this manner is somewhat sporadic with either the angler feeding out too little berley or flooding the water with too much berley. The release of an insufficient amount of berley may fail to attract sufficient numbers of the target species. Conversely flooding the water with berley, while attracting a greater number of species, can result in the attracted species showing little to no interest in the baited line or lure or the like due the excess of berley in the water (i.e. the fish etc tend to take the excess pieces of the berley).

In addition the manual release of berley typically only targets species inhabiting the top water layers. However, some species of pelagic such as snapper typically inhabit the lower water layers. Thus the effectiveness of the berley in attracting species inhabiting the middle to lower layers of water is somewhat diminished.

To better regulate the feed of berley into the water a number of devices have been employed. The simplest of these is a mesh bag, the berley being placed inside the bag. The bag is then suspended in the water via a line which is secured to the side of the boat or the structure from which the angler is fishing.

Another example of a berley distribution device is that discussed in Australian Patent Application No 18528/92, which is essentially a perforated plastic tube with snap on end caps. The berley is loaded inside the tube and the ends sealed before the device is suspended in the water.

Yet another example of a device for controlling the release of berley is a device, colloquially know as the berley bomb. The device is essentially a canister having a weighted nose cone into which the berley is loaded. The door of the canister is then closed before the canister is lowered into the water. The bomb descends to a depth determined by the amount of weight which is loaded into the nose cone. Once at the desired depth, the line tethering the bomb to the boat or the like is jigged, forcing the door of the canister open thereby releasing the berley.

One problem associated with the aforementioned types of distribution devices is that they offer little to no control over the rate of distribution. For example the dissipation of the berley in devices such as AU 18528/92 is dependent upon water currents. In situations where there is as strong current flow the berley is rapidly dispersed from the canister and swept away from the fishing area. Similarly with the berley bomb, the berley is rapidly dispersed in a single motion and is again prone to being swept away from the fishing area negating the effectiveness of the berley.

Clearly it would be advantageous to provide a device which enables the controlled release of berley or other such attractants. Moreover it would be advantageous to provide a berley device that is capable of being utilised in top water, mid water and deep water applications.

### SUMMARY OF THE INVENTION

### Disclosure of the Invention

Accordingly in one aspect of the present invention there is provided an apparatus for the distribution of an attractant, the apparatus including:
a housing having a first plurality of apertures;
a rotatable insert for carrying the attractant and positionable within said housing, the insert including a second plurality of apertures which can be aligned with the first plurality of apertures so as to provide a plurality of openings for the distribution of said attractant;
a closure adapted to engage the housing and retain the insert therein; and
wherein selective rotation of the insert relative to said housing varies the area of said plurality of openings.

The first plurality of apertures may be any closed shape such as a square, rectangle, hexagon, pentagon, triangle or circle. Most preferably the first plurality of apertures are in the form of elongate slots typically equally spaced about the housing.

In one embodiment, the minimum width of the apertures is at least 10 mm such as at least 20 mm or at least 30 mm. Typically the maximum width of the apertures is less than 60 mm, such as 50 mm or less.

In one embodiment the closure includes a pair of opposing lugs disposed on the periphery of the closure. The closure may also include a first shoulder portion for engagement with the insert and a second shoulder portion for engagement with the housing.

Suitably an upstanding member having an aperture therethrough may also be provided on the closure so as to enable the apparatus to be secured to a line. Moreover the provision of such an upstanding member provides a convenient handle by which the apparatus may be carried.

The housing may include a pair of niches disposed on opposing sides of the housing adjacent the top for accepting the lugs of the closure. The housing may also be provided with means to allow the housing to be attached to a fixed line such as a anchor rope. Preferably the means for attachment is in the form of a set of opposing hook members spaced along the housing. Preferably the opposing hook members are constructed from a suitably flexible material such as polyethylene or similar polymers.

Suitably the housing may be provided with upstanding rim portion disposed at the base of the housing to allow the housing to be stood upon its end so as to provide greater stability during the loading of attractant. In addition the provision of the rim portion also allows the apparatus to be conveniently stored or displayed in an upstanding position.

In one embodiment the base of the insert is provided with a pair of opposing flanges and a circular projection which co-operate with apertures provided within the base of housing, whereby displacement of the flanges within the co-operating apertures causes rotation of the insert relative to the housing. Suitably the apparatus may be fitted with a retaining means operable to restrict rotation of the insert relative to the housing. Preferably the retaining means includes at least one rib disposed on the outer surface of the insert for engagement with the inner surface of the body.

The second plurality of apertures may be graduated, wherein the graduation is formed by the variation between a lateral side and an oblique side of the aperture. Preferably the variation between a lateral side and an oblique side is at an angle of approximately 5 to 10°, more preferably about 7.5°. The width of apertures may range, for example, between 10 mm at one end to 50 mm at the opposing end or variations between this range. For example the width of the apertures may range between 20 mm at one end to 50 mm at the opposing end. Suitably the width of the apertures may range between 10 mm at one end to 40 mm at the opposing end. The width of the apertures may range between 10 mm one end to 30 mm at the opposing end. Alternatively the apertures may range between 20 mm one end to 40 mm at the opposing end.

The base of the insert and the housing may also be provided with a third plurality and a fourth plurality of apertures which can also be aligned so as to provide a plurality of openings. Suitably the openings substantially align with the apertures in the closure such that when the apparatus is agitated a current is produced therewithin to further promote the distribution of the attractant.

Suitably a weight or set of weights may be positioned with the insert to allow the apparatus to be used at varying depths.

According to another aspect of the present invention there is provided a method of distribution an attractant, said method including the steps of:
positioning an insert within a housing, said housing including a first set of apertures and the insert including a second plurality of apertures;
placing an attractant within said insert;
closing housing to thereby retain said attractant and said insert therein;
rotating the insert relative to the housing to selectively align said first and second plurality of apertures so as to provide a plurality of openings of a desired area to thereby allow for the distribution of said attractant.

Preferably the attractant is in the form of a frozen extruded sausage. The sausage may contain any number of ingredients such as fish oils (e.g. tuna oil), chicken scraps and carcasses, fish and shellfish carcasses etc.

The method may also include, prior to the step of inserting the attractant, the step of positioning a weight or a set of weights into the insert, whereby varying the amount of weight varies the depth to which the apparatus dives.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is a perspective view of a housing for a distribution apparatus according to one embodiment of the present invention;

FIG. 2A is a perspective view of the insert for a distribution apparatus according to one embodiment of the present invention;

FIG. 2B is a perspective view of the insert for a distribution apparatus according to one embodiment of the present invention;

FIG. 3 is a bottom plan view of the insert according to either FIG. 2A or 2B;

FIG. 4 is a perspective view of the closure member for a distribution apparatus according to one embodiment of the present invention;

FIG. 5A to 5C depicted stages in operation of the assembled distribution apparatus according to one embodiment of the present invention;

FIG. 6 is a perspective view of the assembled distribution apparatus according to a further embodiment of the present.

### DESCRIPTION OF EMBODIMENTS OF THE INVENTION

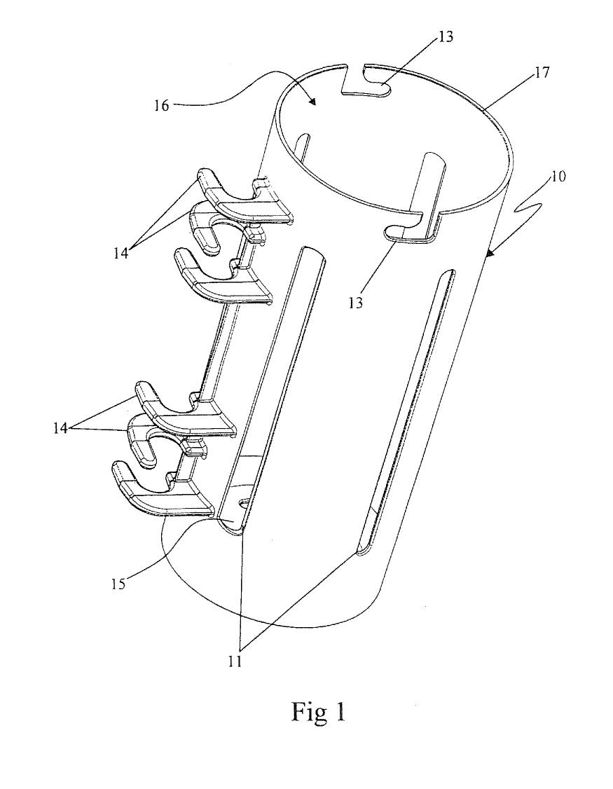

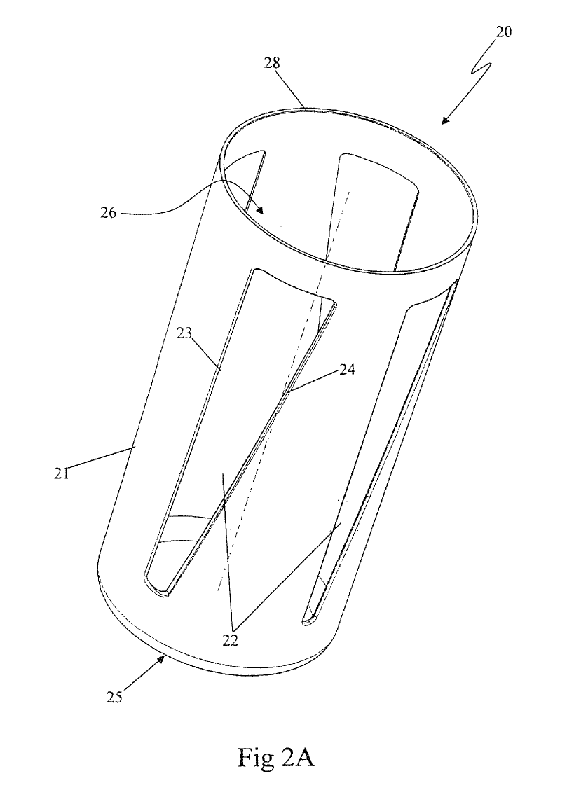

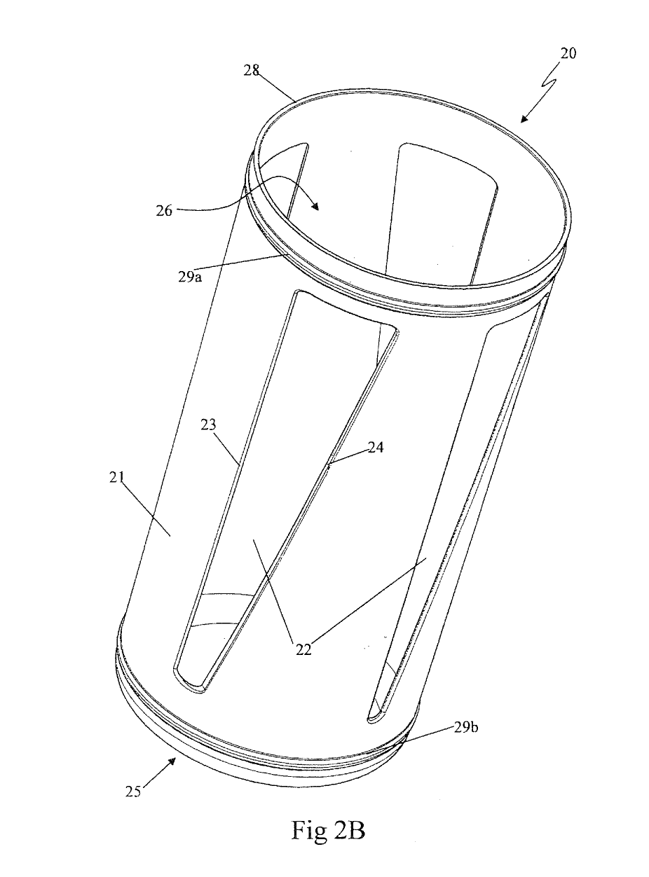

With reference to FIG. 1 there is illustrated one possible arrangement of the housing 10 according to a first embodiment of the distribution apparatus of the present invention. The housing 10 has a base 15 and an open top 16 defined by an upper rim 17. A first plurality of apertures 11 are provided in the housing 10 to allow distribution of the attractant from the apparatus when in use. In the depicted example the plurality of apertures 11 are shown as a set of equally spaced rectangular slats which extend along the length of the housing 10. However, it will be appreciated that the apertures 11 need not be equally spaced about the housing 10. Moreover the apertures 11 may be of any suitable shape, such as a plurality of circular apertures or other such planar shape, providing that they allow the egress of attractant upon alignment with the second set of apertures 22 of the insert 20 (see FIGS. 2A and 2B).

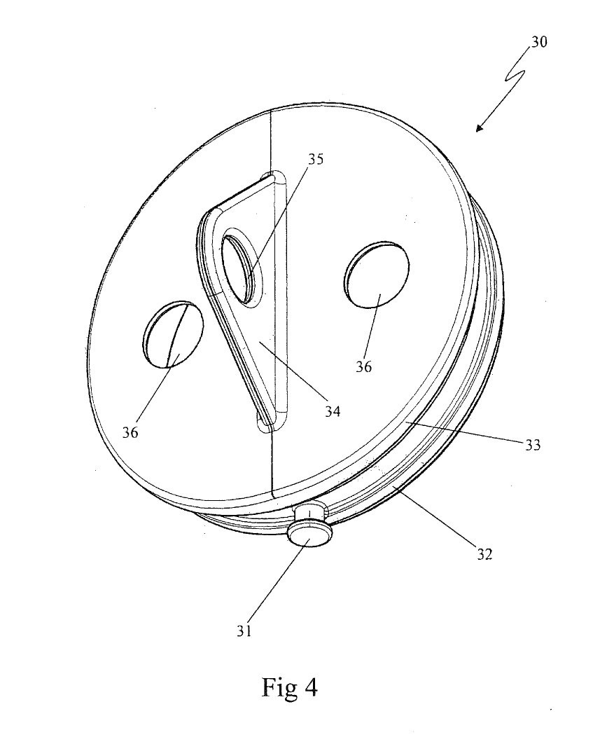

The housing 10 also includes a pair of niches 13 disposed on opposing sides of the housing adjacent the open top 16, for accepting co-operating lugs 31 of the closure 30 (see FIG. 4). Housing 10 may also be provided with a plurality of opposing hook members 14. The hooks are suitably spaced along housing 10 to allow the housing to be woven onto a line which may be trailed from a boat or other suitable structure like a pontoon or wharf. Suitably the hooks are somewhat flexible to enable housing 10 to be woven onto a taut line such as a weighted rope or anchor rope.

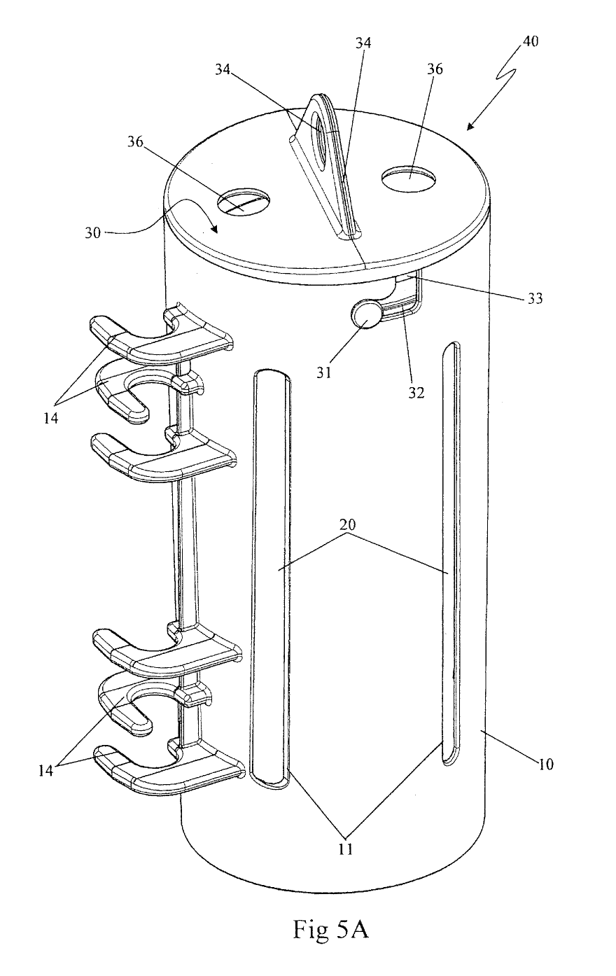

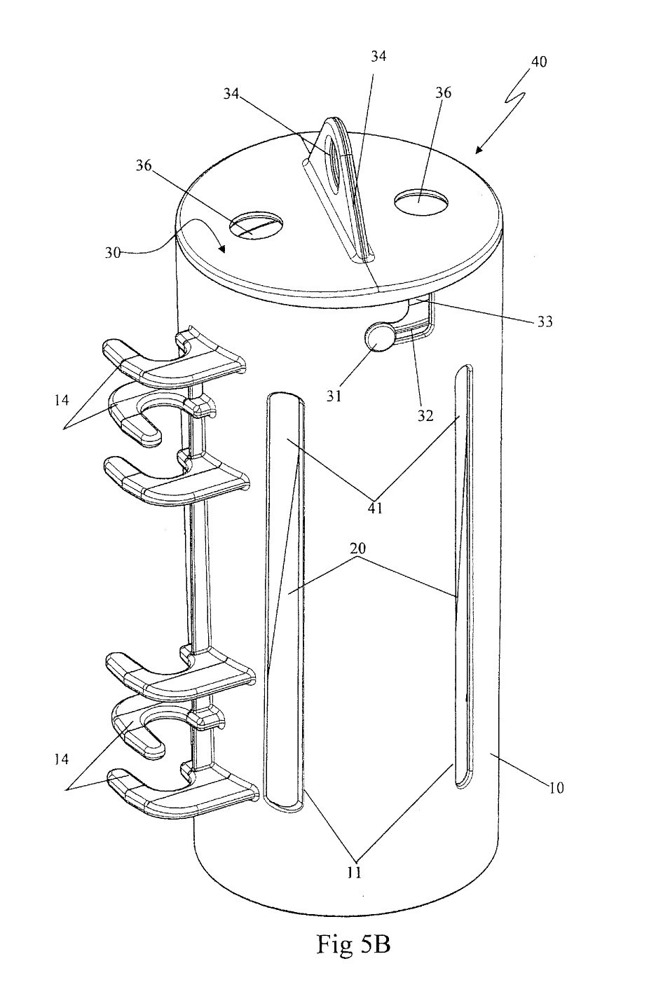

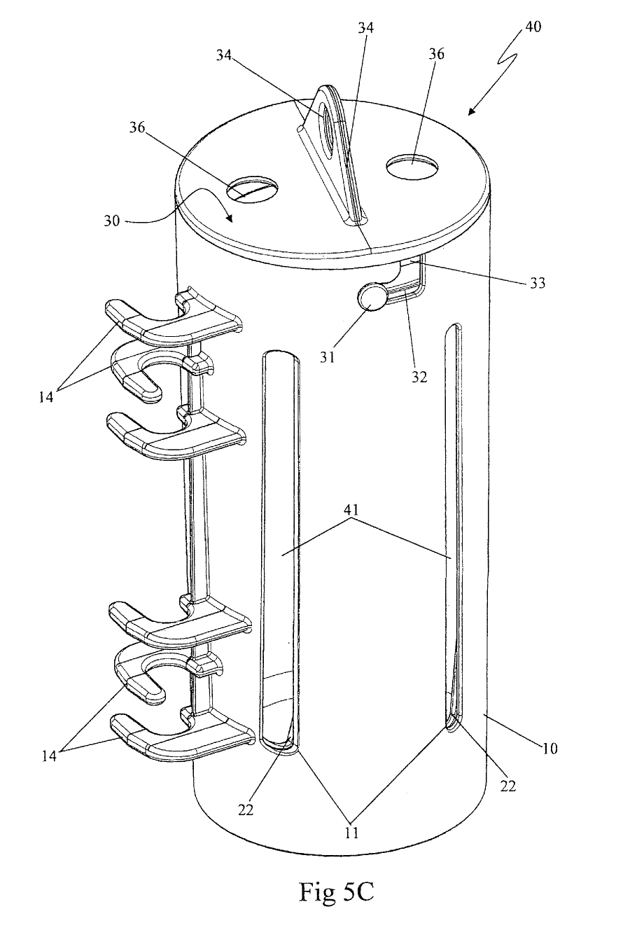

FIG. 2A depicts one possible construction of the insert 20 according to the first embodiment of the distribution apparatus of the present invention. In this instance the insert 20 includes a body 21 having an open top 26, upper rim 28 and a second plurality apertures 22 spanning the length of the body 21. The apertures 22 in the exemplified embodiment are graduated, with the graduation being formed by the variation between the lateral side 23 and the oblique side 24. The graduation in this particular instance is at an angle of approximately 7.5°, that is the oblique side 24 diverges upwardly from the apex with the lateral side 23 at an angle of 7.5°. This provides a variation in the width of the aperture 22 of between 10 mm at the lowest most extent to 50 mm at the upper most extent. It will of course be appreciated that the apertures 22 need not be in the form of a graduated slot and may be any suitable shape (e.g. series of circular apertures or other such closed shapes) provided apertures 22 allow for a variation in the area of the openings 41 formed by alignment of the first and second plurality apertures 11 and 22 upon rotation of the insert relative to the housing 10 (see FIGS. 5B and 5C).

FIG. 2B shows an alternative embodiment of the insert 20. In this example the insert 20 includes a body 21 having an open top 26, upper rim 28 and a second plurality apertures 22 spanning the length of the body 21. Again the apertures 22 in this particular embodiment are graduated, with the graduation being formed by the variation between the lateral side 23 and the oblique side 24. The graduation of the apertures 22 allows for the variation in the area of the openings 41 formed by alignment of the first and second plurality apertures 11 and 22 upon rotation of the insert 20 relative to the housing 10. The insert 20 in this instance includes a retaining means illustrated as a pair of ribs 29a, 29b disposed on the outer surface of the body 21. The first rib 29a is disposed adjacent the upper rim 28 and the second rib 29b is disposed adjacent the base 25. The ribs 29a, 29b act to restrict the movement of the insert 20 relative to the body 10. By restricting the movement of the insert 20 in this manner the likelihood that the area of the openings 41 being inadvertently varied once set to the desired size by the user (e.g. by the jostling of the apparatus by a rough swell or strong ocean currents etc) is greatly reduced.

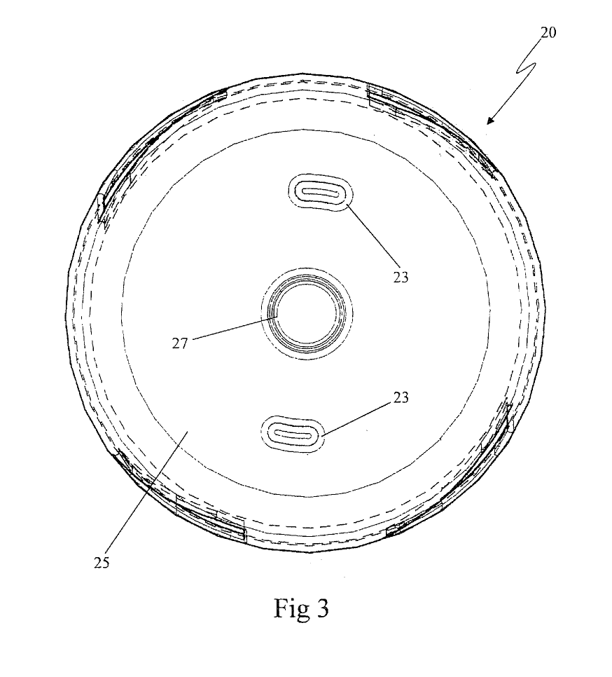

The base 25 of the insert 20 of FIGS. 2A and 2B is shown in FIG. 3. The base in this case is provided with a pair of opposing flanges 23 and a circular projection 27 which co-operate with matching apertures provided within the base 15 of housing 10. In this embodiment the displacement of the flanges 23 within the co-operating apertures of base 15 of housing 10 enables the rotation of the insert 20 relative to the housing 10.

In relation to FIG. 4 there is illustrated one possible version of the closure 30 according to the first embodiment of the distribution apparatus of the present invention. The closure in this instance has a pair of opposing lugs 31 disposed on the periphery of the closure for engagement with the niches 13 of the housing 10. The closure also includes a first shoulder portion 32 for engagement with the upper rim 28 of the insert 20 and a second shoulder portion of 33 for engagement with the upper rim 17 of the housing 10.

An upstanding member 34 having an aperture 35 therethrough may also be provided on the closure 30. The upstanding member 34 acts as both a convenient handle and as a means by which the completely assembled 40 (see FIGS. 5A to 5C) apparatus can be attached to a line. The closure 30 may also include one or more apertures 36. The apertures 36 act to reduce the resistance imparted by the water on the apparatus 40 when agitated upon jigging of the line attached to upstanding member 34. Agitation of the apparatus 40 produces a current flow through apertures 36 and out openings 41 thereby promoting release of the attractant.

FIGS. 5A to 5C illustrate the distribution apparatus in full assembly during various stages of operation. 5A shows the complete assembly in the closed condition with insert 20 position within the housing 10 such that the second plurality of apertures 22 are aligned with the inner wall of the housing 10 and first plurality apertures 11 are aligned with the outer wall of the body 21 of the insert 20 (i.e. there is no overlap between the first and second plurality of apertures).

As can be seen from FIG. 5A the lugs 31 mate with niches 13 of the housing 10 such that the first shoulder portion 32 mates with the upper rim 28 of the insert 20 and the second shoulder portion 33 mates with the upper rim 17 of the housing 10. The engagement of the first shoulder portion 32 with the upper rim 28 of the insert 20 acts to centre the insert 20 so as to minimise the likelihood of attractant being caught between the outer wall of the insert 20 and the inner wall of the housing 10. In some instance the manufactured tolerances of the housing 10, insert 20 and closure 30 can cause misalignment all three components when they are brought together to form the full assembly. In order to ensure that the closure 30 correctly engages the insert 20 and the housing 10 an o-ring may be positioned adjacent the upper rim 28 of the insert 20, An additional o-ring may also be provided near the base 25 of the insert 20 to ensure that it is properly centred within the body 10 before the engagement of the closure 30. Alternatively the o-ring could be provided on the closure 30 adjacent the shoulder portion 32 to ensure proper engagement of the three components. To further reduce the likelihood of any of the contents being caught between the insert and the housing the oblique side of aperture 22 may be provided with a bevelled edge so as to scoop the attractant back into the insert 20 upon rotation of the insert 20 to the closed position. To further reduce the likelihood of any of the contents being caught between the insert and the housing the bevelled edge may act to cut off pieces of the attractant that protrude from the openings as the insert 20 is rotated to the closed position.

FIG. 5B shows the assembled apparatus 40 in a partially open state. Here the insert 20 has been rotated relative to the housing 10, toward the fully open position, via the displacement of the flanges 23 within the co-operating apertures provided within the base of housing 10. This aligns the first plurality of apertures 11 and the second plurality apertures 22 so as to produce openings 41. Further rotation of the insert 20 relative to the housing 10 via further displacement of the flanges 23, varies the area of the openings 41 thereby varying rate of distribution of the attractant. The larger, the area of the opening 41 the greater the distribution rate, with the maximum rate occurring when the insert 20 is rotated to the fully open position thereby producing a plurality of openings 41 each having an area equal to the area of the aperture from the first plurality of apertures 11 with which the opening aligns (see FIG. 5C).

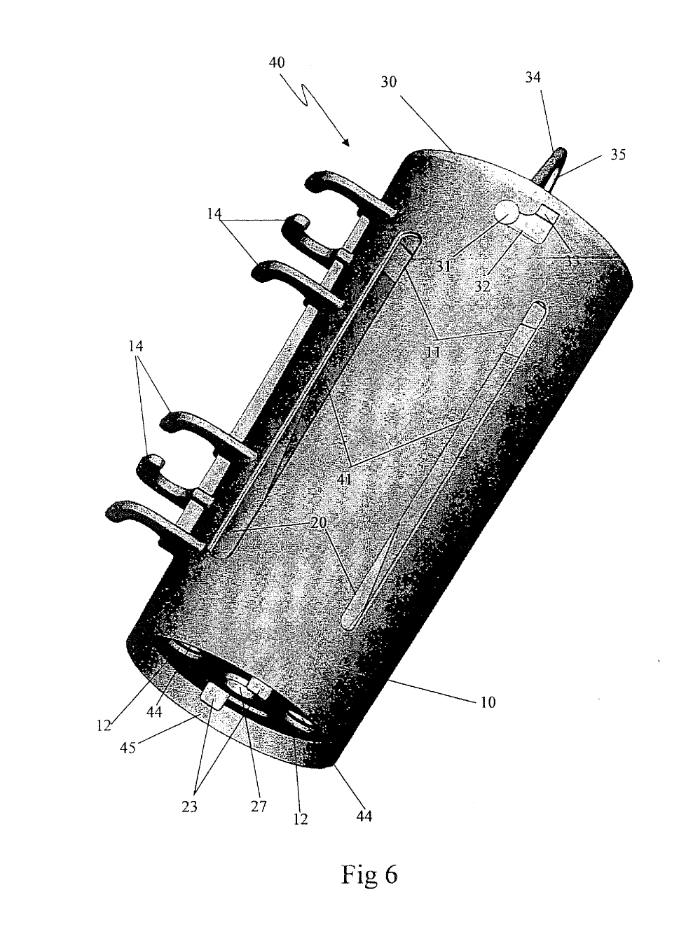

With reference to FIG. 6 there is illustrated a further embodiment of the distribution apparatus of the present invention in the fully assembled state. Insert 20 is positioned within the housing 10 and closure 30 is secured to the housing 10 retaining insert 20 therein. Again the apparatus 40 in a partially open state wherein insert 20 has been rotated relative to the housing 10 aligning the first plurality of apertures 11 and the second plurality apertures 22 so as to produce openings 41.

In this particular exemplified embodiment base 15 of the housing 10 is provided with third plurality of apertures 12 with a fourth plurality of apertures 29 provided in base 25 of insert 20. The provision of apertures 12 and 29 further reduces the resistance imparted on the apparatus when it is agitated to promote the release of the attractant, Upon rotation of the insert 20 relative to the housing 10 via displacement of the flanges 23 both sets of apertures 12 and 29 align to produce openings 44. The openings 44 substantially align with apertures 36 in the closure 30, on agitation of the apparatus 40 a current is produce through apertures 36 and openings 44 thereby promoting release of the attractant.

Base 15 may also include an upstanding rim portion 45 enabling the apparatus to be stood upon is end. Standing the apparatus 40 upon rim 45 provides greater stability during the loading of attractant into the apparatus 40. In addition the provision of rim 45 allows the apparatus to be conveniently stored or displayed in an upstanding position.

Suitably each of the exemplified embodiments discussed above may be fitted with a retaining means which acts to the hold the insert 20 in a desired position relative to the housing 10. Once the insert 20 is rotated. relative to the housing 10 in order to produce the desired opening 41 the retaining means is enabled to thereby temporarily restrict further rotation of the insert 20 within the housing.

In addition a weight or a set of weights may be utilised in conjunction with each of the exemplified embodiments discussed above. The weight or set of weights may be positioned within the insert prior to the insertion of the desired attractant. Varying the amount of weight within the insert varies the depth to which the apparatus descends. In the above examples, the completed assembly has been designed with a specific type of attractant in mind. In particular, the apparatus has been specifically designed for the controlled release of a berley in the form of a frozen extruded sausage. The sausage can be formed by firstly blending a number of ingredients such as fish oils (e.g. tuna oil), chicken scraps and carcasses, fish and shellfish carcasses etc. This mixture is then extruded out through a die to produce the sausage shape which is subsequently frozen. While the above examples have been designed with the use of the extruded sausage in mind, it will be appreciated that apparatus is also capable of distributing various forms of berley frozen or otherwise.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. An apparatus for the distribution of an attractant the apparatus comprising:
a housing having a first plurality of apertures;
a rotatable insert for carrying the attractant and positionable within said housing, the insert comprising a second plurality of graduated apertures which can be aligned with the first plurality of apertures so as to provide a plurality of openings for the distribution of said attractant between the insert and said housing;
a closure adapted to engage the housing and retain the insert therein; and
wherein selective rotation of the insert relative to said housing varies the area of said plurality of openings.

2. The apparatus of claim 1 wherein said closure comprises a first shoulder portion for engagement with the insert and a second shoulder portion for engagement with the housing.

3. The apparatus of claim 2 wherein said closure comprises a pair of opposing lugs.

4. The apparatus of claim 3 wherein said closure further comprises an upstanding member having an aperture therethrough.

5. The apparatus of claim 1 wherein the first plurality of apertures and the second plurality of apertures are in the form of a closed shape.

6. The apparatus of claim 5 wherein the first set of apertures are in the form of elongate slots equally spaced about the housing.

7. The apparatus of claim 1 wherein the housing further includes an upstanding rim portion disposed at the base of the housing.

8. The apparatus claim 1 wherein said insert includes a pair of opposing flanges and a circular projection which cooperate with apertures provided within the base of the housing.

9. The apparatus of claim 1 wherein the graduation is formed by an angular variation between a lateral side and an oblique side of each of the second plurality of apertures.

10. The apparatus of claim 9 wherein the angular variation between the lateral and oblique sides of each of the second plurality of apertures is approximately 7.5°.

11. The apparatus of claim 10 wherein each of the second plurality of apertures has a width ranging from 10 mm to 50 mm.

12. The apparatus of claim 1 wherein a third plurality of apertures is provided in the housing's base and a fourth plurality of apertures is provided within the base of the insert wherein said third and fourth plurality of apertures can be aligned to produce a second plurality of openings and selective rotation of the insert relative to said housing varies the area of said second plurality of openings.

13. The apparatus of claim 1 wherein the insert further comprises a retaining means wherein said retaining means is operable to restrict rotation of the insert relative to the body.

14. The apparatus of claim 13 wherein the retaining means comprises at least one rib for engagement with the body.

15. The apparatus of claim 1 wherein said apparatus is weighted to enable said apparatus to descend to a desired depth.

16. A method of distributing an attractant, said method comprising the steps of:
positioning an insert within a housing, said housing including a first set of apertures and the insert including a second plurality of apertures;
placing an attractant within said insert;
engaging a closure with said housing to thereby retain said attractant and said insert therein;
rotating the insert relative to the housing to align said the first and second plurality of apertures so as to provide a plurality of openings of a desired area to thereby allow for the distribution of said attractant.

17. The method of claim 16 wherein said method comprises prior to the step of positioning the attractant in said insert, the step of positioning weight within the insert so as to enable said apparatus to descend to a desired depth.

18. The method of claim 16 further comprising the step of agitating the apparatus to promote the release of the attractant.

19. An apparatus for the distribution of an attractant, the apparatus comprising:
a housing having a first plurality of apertures;
a rotatable insert for carrying the attractant and positionable within said housing, the insert comprising a second plurality of apertures which can be aligned with the first plurality of apertures so as to provide a plurality of openings for the distribution of said attractant;
a closure adapted to engage the housing and retain the insert therein said closure further including at least one aperture; and
wherein selective rotation of the insert relative to said housing varies the area of said plurality of openings and wherein the at least one aperture provided in said closure, the at least one aperture cooperating with said openings to induce a current flow to disperse the attractant on agitation of the apparatus.

20. An apparatus For the distribution of an attractant the apparatus comprising:
a housing having a first plurality of apertures;
a rotatable insert for carrying the attractant and positionable within said housing, the insert comprising a second plurality of apertures which can be aligned with the first plurality of apertures so as to provide a plurality of openings for the distribution of said attractant between the insert and said housing, said apertures further including at least one bevelled edge;
a closure adapted to engage the housing and retain the insert therein; and
wherein selective rotation of the insert relative to said housing varies the area of said plurality of openings and wherein the at least one bevelled edge acts to reduce or prevent lodgement of the attractant between the housing and insert upon selective rotation of the insert.

21. An apparatus for the distribution of an attractant the apparatus comprising:
a housing having a first plurality of apertures, said housing further comprising at least one adaptation which permits the housing to be secured to a line;
a rotatable insert for carrying the attractant and positionable within said housing, the insert comprising a second plurality of graduated apertures which can be aligned with the first plurality of apertures so as to provide a plurality of openings for the distribution of said attractant between the insert and said housing;
a closure adapted to engage the housing and retain the insert therein; and
wherein selective rotation of the insert relative to said housing varies the area of said plurality of openings.

22. The apparatus of claim 21 wherein the at least one adaptation comprises a plurality of opposing hook members spaced along the housing.
